(19) United States
(12) Patent Application Publication
(10) Pub. No.: US 2025/0293555 A1
(43) Pub. Date: Sep. 18, 2025

(54) WIND-TURBINE-GENERATOR STATOR FOR A WIND TURBINE WITH PREFORMED COILS, AS WELL AS A METHOD FOR MANUFACTURING A WIND-TURBINE-GENERATOR STATOR

(71) Applicant: Wobben Properties GmbH, Aurich (DE)

(72) Inventors: Tobias Muik, Bensheim (DE); Harri Vihriälä, Lilienthal (DE); Charan Karapanahalli, Hemsbach (DE); Stephan Jöckel, Kleinniedesheim (DE); Manuel Feith, Esens (DE); Renke de Buhr, Aurich (DE)

(73) Assignee: Wobben Properties GmbH, Aurich (DE)

(21) Appl. No.: 18/971,849

(22) Filed: Dec. 6, 2024

(30) Foreign Application Priority Data
Dec. 8, 2023 (EP) 23215157.1

(51) Int. Cl. H02K 1/16; H02K 7/18; H02K 15/02

(52) U.S. Cl. CPC H02K 1/16; H02K 7/183; H02K 15/02

(57) ABSTRACT

A wind-turbine-generator stator includes a plurality of stator teeth; stator grooves arranged alternately in a circumferential manner; and a plurality of preformed coils inserted into the stator grooves. Each performed coils is a partial winding of at least one electrical conductor. The partial winding has winding heads arranged at two opposite ends and two parallel limbs. Each of the two parallel limbs has a corresponding inner side and a corresponding outer side. In one of the stator grooves, the two parallel limbs of different preformed coils are inserted such that corresponding outer sides of the two parallel limbs face each other and corresponding inner sides of the two parallel limbs face a different one of the stator teeth. A wedge is pressed between the corresponding outer sides of the two parallel limbs such that a force is exerted onto the corresponding outer side of the two parallel limbs.

### CROSS-REFERENCE TO RELATED APPLICATIONS

This application claims the benefit of priority to European application number 23215157.14, filed on Dec. 8, 2023, entitled WIND-TURBINE-GENERATOR STATOR FOR A WIND TURBINE WITH PREFORMED COILS, AS WELL AS A METHOD FOR MANUFACTURING A WIND-TURBINE-GENERATOR STATOR, which is expressly incorporated by reference herein in its entirety.

### TECHNICAL FIELD

The present disclosure relates to the field of wind turbines and, in particular, wind-turbine generators. A wind-turbine generator corresponds to the generator of a wind turbine, which, driven by an aerodynamic rotor of the wind turbine, converts kinetic energy from the wind into electrical energy.

### BACKGROUND

Wind-turbine generators comprise a wind-turbine-generator stator, i.e., a stator of a wind-turbine generator, and a wind-turbine generator rotor, i.e., a rotor of a wind-turbine generator. The wind-turbine generator rotor is driven by an aerodynamic rotor with rotor blades and thus rotates with respect to the wind-turbine-generator stator. The rotor of the wind-turbine generator provides a rotating magnetic field which, by rotating the rotor, induces an electric current into a winding of the wind-turbine-generator stator consisting of electrical conductors in order to generate electrical energy from the rotational energy.

### SUMMARY

The present disclosure relates, in particular, to wind-turbine-generator stators with a winding formed from preformed coils. Preformed coils are preformed sections of the winding, i.e., winding sections in which at least one conductor, usually with a rectangular or square cross-section, is wound in a plurality of windings before being arranged in the stator. After winding and other method steps, the preformed coil comprises an essentially stable shape so that it is essentially inserted into stator grooves of the wind-turbine-generator stator without further adjustment of its shape.

In accordance with this, a winding made of preformed coils differs from a wire winding, in which the winding is made by winding a wire around groove-limiting teeth. Preformed coils enable a higher power density due to a higher fill factor of the stator grooves.

Due to the increased fill factor of the stator grooves, which is possible due to the use of preformed coils, the current flowing in the preformed coils, which is converted into heat by a resistance of the preformed coils, creates temperatures in the wind-turbine-generator stator that are higher than in wire windings. The reason for this is the comparatively higher current density in the groove when using the preformed coils. The high temperatures can lead to damage to the insulation of the preformed coils and thus to ground faults during operation.

Therefore, various measures are taken to cool the coils, for example through active or passive ventilation, and/or to design the insulation to be heat-resistant. These measures are often very complex and cooling in the area of the densely packed stator grooves in particular is inefficient due to the small surface area that can be reached for cooling.

The present disclosure is therefore directed to address the problems of prior art. In particular, an efficient measure is to be found to improve heat generation in a wind-turbine-generator stator, in particular, from a large wind-turbine generator with, for example, more than 5 m or more than 10 m air gap diameter and more than 1 MW nominal power, the winding of which is made with preformed coils. In any case, an alternative to what is known from prior art is to be found.

Aspects of the present disclosure are directed to a wind-turbine-generator stator according to claim 1.

Accordingly, a wind-turbine-generator stator is proposed, which comprises a plurality of stator teeth and stator grooves, wherein the stator teeth and stator grooves are arranged alternately with each other. The wind-turbine-generator stator is designed as a wind-turbine-generator stator for a wind-turbine generator with an external rotor or outer rotor. The stator grooves and stator teeth are therefore formed on the outer circumference of the wind-turbine-generator stator.

In addition, the wind-turbine-generator stator comprises a plurality of preformed coils, wherein each preformed coil of a partial winding corresponds to a winding of the wind-turbine-generator stator. A partial winding comprises a plurality of windings formed from at least one conductor. The preformed coils are inserted into the stator grooves. The preformed coils are wound out of the conductor in such a way that the partial winding, i.e., the preformed coil, is formed by two winding heads arranged at opposite ends of the partial winding and two limbs running essentially parallel.

In at least one stator groove, two limbs of different preformed coils are inserted. Each of the limbs comprises an outer side and an inner side. The outer side of the limb is referred to as an area of the limb of a preformed coil that is formed by the windings of the conductor or the conductors arranged next to one another if they are arranged on top of one another in a plurality of layers. Due to the plurality of layers, a limb thus comprises an outer side that points away from a centre of mass of the preformed coil. Accordingly, an inner side of a limb of the preformed coil is referred to as the surface formed by the plurality of layers of the conductor or conductors arranged on top of each other and whose surfaces point towards the centre of mass or centre of mass of the preformed coil. Lateral surfaces connecting the inner side and the outer side of a limb correspond to a width of the conductor or the sum of the widths of the adjacent conductors and are formed by the upper or lower conductor or conductors of the multi-layer assembly. The conductor or conductors are rectangular conductors, i.e., conductors with a square or rectangular cross-section so that the surfaces are formed by the edges of the conductor or conductors due to the multi-layer arrangement.

The limbs of the two different preformed coils are inserted into a stator groove in such a way that the outer sides of the two inserted limbs are facing each other. The inner sides of the limbs are each facing a different one of two stator teeth bordering the stator groove.

According to the present disclosure, a wedge is pressed in between the outer sides of the limbs so that, on each of the limbs, a force is exerted on the outer side of the respective limb. The term wedge is used here for a body that comprises two lateral surfaces that converge at an acute angle and that comprises an isosceles triangular shape. However, the term wedge also comprises bodies with a cross-section that is trapezoidal, particularly isosceles trapezoidal, and which are referred to as trapezoidal prisms or trapezohedrons, for example.

According to some aspects of the present disclosure, the wedge is adapted in such a way that it runs essentially along the entire depth of the stator groove or at least in a predominant part of the depth of the stator groove with its height or width, thereby exerting an essentially equally distributed force on both outer sides of the limbs. The height or width of the wedge is the distance between the surfaces connecting the lateral surfaces, which are essentially parallel to each other. The wedge is thus adapted in shape to the depth of the stator groove, the outer sides of the limbs and a gap between the limbs that would have existed in the absence of the wedge in order to fill this gap essentially evenly and completely in addition to exerting the forces on the outer sides.

The present disclosure provide one or more improvements to wind-turbine-generator stators having a high heat development because the contact between the limbs of the preformed coils and the stator teeth is partially insufficient to dissipate heat from the preformed coils via the stator teeth. Preformed coils, for example, are held in position by soaking the wind-turbine-generator stator in a resin and/or a groove sealing element, after they have previously been inserted into the stator grooves via the stator teeth without mechanical preloading. Until now, resin or air could therefore be present between the inner side of the limbs and the stator tooth so that a dissipation of heat from the limb into the stator tooth could not take place in an ideal manner.

Through the wedge according to some aspects of the present disclosure, the limb of each of the preformed coils inserted into the stator groove is now pressed against the stator tooth after the insertion of the preformed coils so that there is an essentially ideal contact between the limbs of the preformed coils and the corresponding stator teeth, in particular, running over the entire surface of the stator tooth. Improved heat dissipation is thus possible so that only by pressing in the wedge, i.e., with comparatively little effort, a very high reduction in heat generation in the area of the preformed coil occurs.

In accordance with a first example embodiment, the wedge is made of a plastic. The wedge is made of a glass-fibre reinforced plastic (GRP). Due to the manufacturing of the wedge from plastic, particularly glass-fibre reinforced plastic, it is dimensionally stable and non-conductive. In addition, plastic, and particularly glass-fibre reinforced plastic, comprises a high elastic energy absorption with a relatively low modulus of elasticity so that a force is continuously exerted on the limbs of the preformed coils after pressing.

In accordance with another example embodiment, a fabric or non-woven material is arranged between the wedge and the limbs of the preformed coils, i.e., in particular, the outer sides of the limbs. Non-woven material refers to the short form of a non-woven fabric. The fabric or non-woven material is, for example, a fabric or non-woven material made of polyethylene terephthalate, or PET for short, and thus corresponds to a PET fabric, PET felt or PET non-woven material, for example. The fabric or non-woven material is formed with glass fibres and thus a glass fabric or glass non-woven material. The frictional resistance is increased by providing a fabric or non-woven material, particularly over a large area, i.e., evenly distributed, with a uniform layer thickness, for example between 0.1 mm and 0.5 mm, between the wedge and the limbs of the preformed coils.

Aspects of the present disclosure are based on the finding that plastic or glass-fibre reinforced plastic usually comprises a low frictional resistance. By inserting the fabric or non-woven material between the wedge and the limbs, the frictional resistance, which is comparatively higher of the fabric or non-woven material, is increased and the wedge remains more securely pressed between the limbs of the preformed coils in the stator groove. The use of PET fabric, PET non-woven material, glass fabric or glass non-woven material is particularly favourable, as it can be provided cheaply and with high frictional resistance.

In accordance with another example embodiment, a fabric or non-woven material is also inserted between both limbs of the preformed coils and a groove wall of the stator groove, which corresponds to the fabric or non-woven material between the limbs and the wedge, or a glass or PET fabric or glass or PET non-woven material. The frictional resistance between the preformed coils and the stator teeth limiting the stator groove, which together with a groove base form the groove wall, can therefore also be increased so that the hold of the preformed coils in the stator grooves is improved.

In accordance with another example embodiment, the fabric or non-woven material, namely the fabric or non-woven material between the wedge and the limbs and/or between both limbs and a groove wall of the stator groove, is a resin-impregnated fabric or resin-impregnated non-woven material and a resin-impregnated glass non-woven material. Depending on whether the wind-turbine-generator stator has already been heated at a production step or whether it is still to be carried out, the resin-soaked fabric or resin-soaked non-woven material is in a half-cured state, before the heating process, or in a fully cured state, after the heating process. The process step can also be referred to as baking the wind-turbine-generator stator. The resin-impregnated fabric or resin-impregnated non-woven fabric is therefore referred to as a “B-stage” fabric or non-woven fabric before the heating process and as a “C-stage” fabric or non-woven fabric after curing through the heating process.

By using the resin-impregnated fabric or resin-impregnated non-woven material, stability is further increased in addition to the increased friction between the limbs of the preformed coil and stator teeth on the one hand and the wedge on the other hand. In particular, the limbs on the stator teeth and the wedge are glued to the limbs by the cured resin. This ensures a secure hold.

In accordance with another example embodiment, the stator groove is sealed with a groove sealing element. The groove sealing element, which is also called a groove locking wedge, is inserted, pressed or fitted between the stator teeth in the inlet area into the stator groove through which the limbs of the preformed coils are inserted in order to close the stator groove, particularly in the radial direction of the stator or the stator groove, and thus hold the preformed coils even more securely in the stator groove.

In accordance with another example embodiment, the groove sealing element is made of a plastic, in particular, a glass-fibre reinforced plastic. In one example, the material from which the groove sealing element is made corresponds to the material from which the wedge between the limbs of the preformed coils is made.

Due to the high elastic energy absorption with a relatively low modulus of elasticity, a groove sealing element made of plastic or glass-fibre reinforced plastic can be firmly inserted into the stator groove and securely retains its position there.

In accordance with another example embodiment, a filling material, such as a fabric or a non-woven material for example, is arranged between the groove sealing element and the preformed coils inserted into the stator groove and the wedge. The lateral surfaces of the limbs of the preformed coils and a rear side of the wedge form a surface of the groove over which the fabric or non-woven material is arranged. The fabric or non-woven material is then arranged between the latter surface and the groove sealing element after the groove has been sealed. The fabric or non-woven material is used to increase the frictional resistance between the groove sealing element and the preformed coils, as well as the wedge between the limbs of the preformed coils to hold the groove sealing element securely in position. In one example, the filling material is a plastic non-woven material, such as a polyester non-woven material with a thickness of, in one example, 1 mm to 4 mm, or in another example, a thickness between 2 mm and 3 mm. In one example, the filling material is also a resin-impregnated fabric or resin-impregnated non-woven material in order to firmly glue the groove sealing element in the aforementioned heating process or method. The use of the resin-impregnated material for bonding is also known as the resin-rich method.

Furthermore, the present disclosure relates to a method. The method is used to manufacture a wind-turbine-generator stator in accordance with one of the aforementioned embodiments. In a first step of the method, a wind-turbine generator yoke is provided with a plurality of stator teeth and stator grooves arranged all around. At a further step of the method, two limbs of different preformed coils are inserted into at least one stator groove in such a way that the outer sides of the limbs face each other and the inner sides of the limbs each face a different one of the two stator teeth bordering the stator groove. At a further step, a wedge is pressed between the outer sides of the limbs so that the wedge exerts a force on each of the limbs on the outer side of the respective limb.

In accordance with one example embodiment of the method, before inserting or pressing the wedge into an area between the limbs, in particular, the outer sides of the limbs, a fabric or non-woven fabric is inserted or arranged on the wedge so that, after the wedge has been pressed, a layer of fabric or non-woven fabric is arranged between the wedge and the outer sides of the limbs.

In accordance with another example embodiment, before the limbs are inserted into the stator groove, a fabric or non-woven material is inserted into the stator groove so that the fabric or non-woven material, in particular a layer of fabric or non-woven material, is arranged between a groove wall and the preformed coils.

In accordance with another example embodiment, before inserting the limbs of the preformed coils into the stator groove, a fabric or non-woven material is inserted into the stator groove, wherein the fabric or non-woven material comprises a width longer than the width of the stator groove plus twice the depth of the stator groove. In one example, the width essentially corresponds to four times the groove depth plus twice the groove width. After inserting the limbs of the preformed coils, the fabric or non-woven material is arranged over each of the limbs of the preformed coils and inserted into an area between the limbs. The wedge is then pressed into the stator groove together with the inserted non-woven material in the area between the limbs. In one example, the wedge is pressed flush with the lateral surfaces of the limbs and the fabric in the area of the lateral surfaces of the limbs is removed by cutting so that the fabric remains arranged between the wedge and the outer sides of the limbs and between the limbs and the stator groove, and normal vectors of the lateral surfaces of the limbs pointing away from the groove base or groove bottom, and wedge form an essentially flat surface.

In accordance with another example embodiment, before inserting the limbs of the preformed coil into the stator groove, a fabric or non-woven material is inserted into the stator groove, wherein the fabric or non-woven material comprises a width that is substantially equal to the width of the stator groove plus two times the depth of the stator groove. The limbs of the preformed coils are then inserted into the groove.

In accordance with another embodiment, after inserting the limbs into the stator groove, a fabric or non-woven material is provided in such a way that it is arranged between the wedge and the limbs after the wedge has been pressed in. For this purpose, the fabric or non-woven material is either arranged in the area between the preformed coils before the wedge is pressed in or arranged around one edge or side of the wedge on the two lateral surfaces around the wedge and pressed together with the wedge into the area between the preformed coils.

In accordance with another embodiment, a groove sealing element is fitted into the stator groove after the wedge has been pressed in to close the stator groove. In accordance with another embodiment, before fitting the groove sealing element, a layer of filling material, which is, in particular, a plastic, such as a fabric or a non-woven material for example, is applied to a surface formed by the wedge and lateral surfaces of the limbs of the preformed coils so that, once the groove sealing element has been fitted, the filling material is arranged between the surface and the groove sealing element.

Furthermore, the present disclosure relates to a wind-turbine generator comprising a wind-turbine-generator stator in accordance with one of the aforementioned example embodiments, and manufactured in accordance with one or more example methods described herein.

Furthermore, the present disclosure relates to a wind turbine with a wind-turbine generator according to the present disclosure or a wind-turbine-generator stator in accordance with one or more example embodiments of the present disclosure, which is/are manufactured according to example methods described herein.

### BRIEF DESCRIPTION OF THE DRAWINGS

Further embodiments emerge from the exemplary embodiments explained in more detail in the figures. Hereby, the figures show:

FIG. 1 illustrates a wind turbine according to one example embodiment;

FIG. 2 illustrates a section of a wind-turbine-generator stator according to one example embodiment;

FIG. 3 illustrates a preformed coil according to one example embodiment;

FIG. 4 illustrates a stator groove of the wind-turbine-generator stator with preformed coil limbs according to one example embodiment;

FIG. 5 illustrates steps of a method according to one example embodiment;

FIGS. 6a-6c illustrate steps of a method according to one example embodiment; and

FIGS. 7a-7c illustrate steps of a method according to one example embodiment.

### DETAILED DESCRIPTION

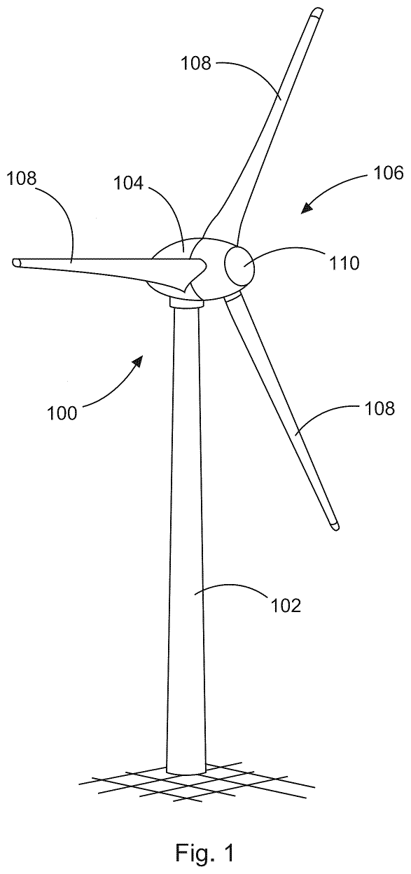

FIG. 1 shows a schematic illustration of a wind turbine 100 according to tone example embodiment. The wind turbine 100 comprises a tower 102 and a nacelle 104 on the tower 102. An aerodynamic rotor 106 with three rotor blades 108 and a spinner 110 is provided for nacelle 104. During the operation of wind turbine 100, the aerodynamic rotor 106 is set in a rotational movement by the wind and thus also rotates an electrodynamic rotor or rotor of a wind-turbine generator, which is directly or indirectly coupled with the aerodynamic rotor 106. The electric wind-turbine generator is arranged in nacelle 104 and generates electrical energy. The pitch angles of the rotor blades 108 can be changed by pitch motors on the rotor blade roots of the respective rotor blades 108.

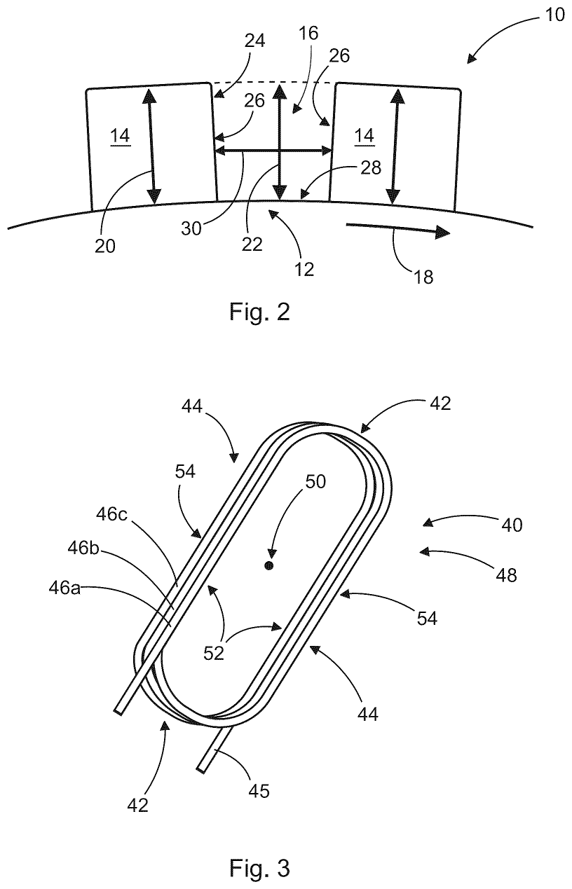

FIG. 2 shows a section of a wind-turbine-generator stator 10 of a wind-turbine generator. In one example, the wind-turbine-generator stator 10 comprises a yoke 12 on which stator teeth 14 and stator grooves 16 are formed. In the circumferential direction 18, the stator teeth 14 and the stator grooves 16 alternate, in a circumferential manner. Each stator tooth 14 comprises a height 20, which simultaneously corresponds to a depth 22 of the stator groove 16. The stator groove 16 comprises a wall or groove wall 24 which comprises two side walls 26 which are formed by the adjacent stator teeth 14 and can therefore be simultaneously described as the wall of the stator tooth 14. Furthermore, the stator groove 16 comprises a groove bottom or groove base 28, which is also part of the groove wall 28. The stator groove 16 also comprises a width 30, which increases from the groove base 28 along the depth 22 of the stator groove 16 by a curved shape of the yoke 12. This applies here, since the present disclosure relates to a wind turbine 100 which comprises a wind-turbine generator which is designed as an external rotor.

FIG. 3 shows a preformed coil 40, which comprises two winding heads 42 and two limbs 44. The preformed coil 40 is made of an electrical conductor 45 wound in a plurality of windings 46a, 46b, 46c to correspond to a partial winding 48 for making an entire winding of the wind-turbine-generator stator 10. Starting from a centre of mass 50 of the preformed coil 40, the preformed coil 40 comprises an inner side 52 and an outer side 54. In one example, the inner side 52 and the outer side 54 are formed by the stacked windings 46a, 46b, 46c of the electrical conductor 45, which is therefore multi-layered. In one example, the preformed coil thus forms a surface which is essentially flat on the outer side 54 and on the inner side 52 by wrapping (not shown) the layers of the preformed coil 40. Wrapping the layers of the preformed coil 40 can also be referred to as the main insulation and can be made of mica material. In one example, the mica material is formed around the wound conductor(s) of the preformed coil and is also resin-impregnated so that after a heating process or baking process, the wrapping will hold securely to the conductor.

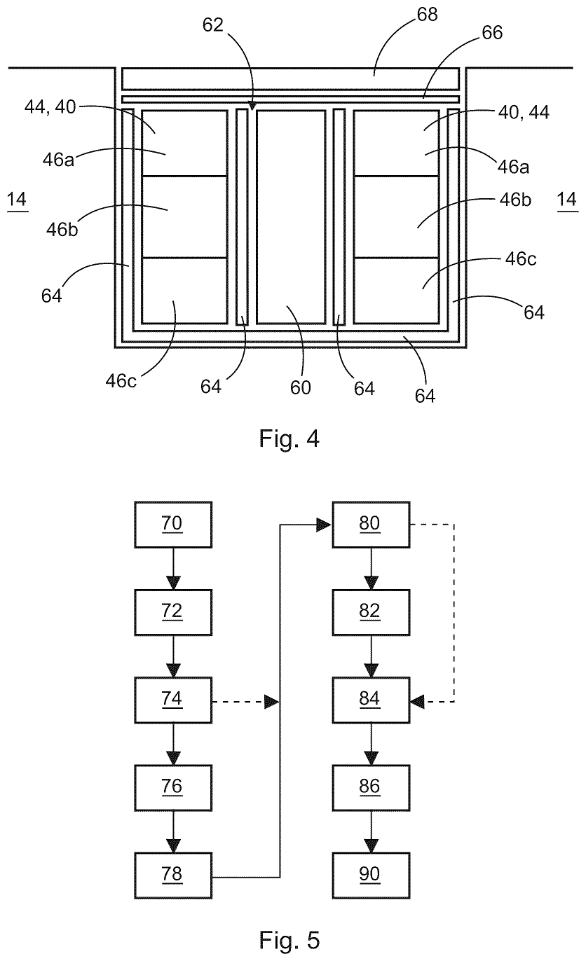

FIG. 4 schematically shows a stator groove 16 of a wind-turbine-generator stator 10, in which two limbs 44 of different preformed coils 40 are inserted. The representation is schematic and if a wind-turbine-generator stator 10 is assumed for a wind-turbine generator that comprises an external rotor, the stator groove 16 is to be considered as V-shaped, as shown in FIG. 2. Furthermore, a wedge 60 is pressed into an area 62 between the limbs 44. Accordingly, the wedge 60 is also not rectangular, but rather V-shaped or trapezoidal. In addition, there is a non-woven material 64 in the area between the limbs 44 and the groove bottom 28 as well as the side walls 26 of the stator groove 16. The non-woven material 64 is also arranged between the inner sides 52 of the limbs 44 and the wedge 60. A filling material 66 and a groove sealing element 68 close the stator groove 16.

FIG. 5 shows the steps for manufacturing a wind-turbine-generator stator 10 in accordance with an exemplary embodiment. At step 70, a yoke 12 of a wind-turbine-generator stator 10 is first provided, and at step 72, a fabric or non-woven material 64 is inserted into stator grooves 16 of the yoke 12. At step 74, preformed coils 40 are inserted into the stator grooves 16. At step 76, protruding fabric or non-woven material 64 is arranged over the limbs 44 of the preformed coils 40 into a intermediate space that forms between the inserted limbs 44 of different preformed coils 40 in a stator groove 16, and the fabric or non-woven material 64 is inserted into the area between the limbs 44 at step 78. At step 80, a wedge 60 is pressed into the area between the limbs 44, which lie in a stator groove 16, and at step 82, the fabric or non-woven material 64 positioned on the lateral surfaces 52, 54 of the limbs 44 is removed. Steps 76 to 82 correspond to a first alternative, wherein, in accordance with a second alternative, the fabric or non-woven material is inserted appropriately at step 74, and step 80 is carried out directly after step 74, wherein the wedge is then pressed into the area between the limbs 44 at step 80 together with fabric or non-woven material wrapped around the wedge. In accordance with a second alternative, step 82 is dispensed with. At step 84, a filling material 66, for example another fabric, is arranged over a surface formed by sides 52, 54 of the limbs 44 and the wedge 60 and the stator groove 16 is sealed at step 86 with a groove sealing element 68. At step 90, the wind-turbine-generator stator 10 is heated or baked.

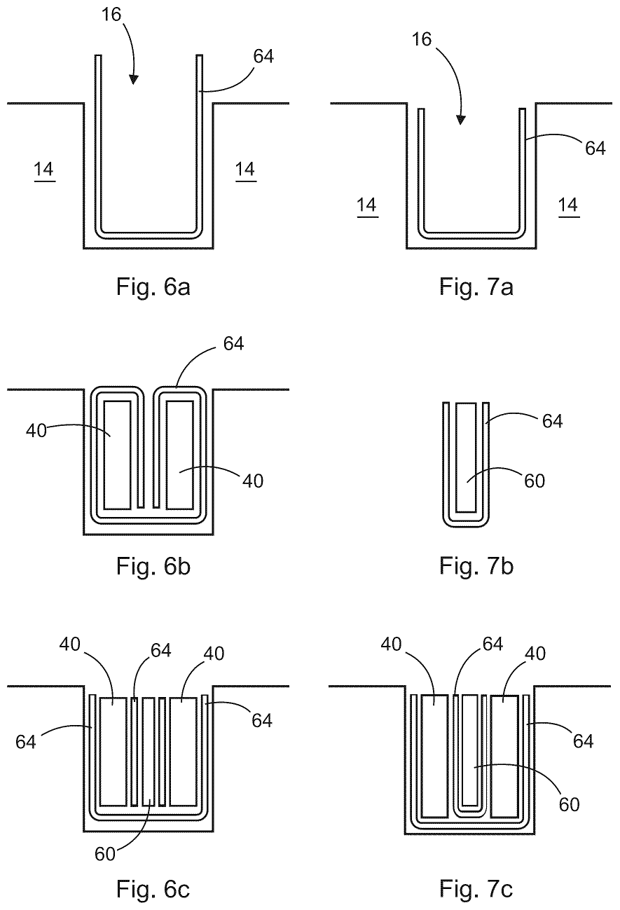

FIG. 6a shows how at step 72 the fabric or non-woven material 64 is inserted into the stator groove 16. FIG. 6b shows how, at step 76, after insertion of the preformed coils 40, the fabric or non-woven material 64 is arranged over sides 52, 54 of the limbs 44 of preformed coils 40 and inserted into the area between the limbs 44 of preformed coils 40. FIG. 6c shows how, after step 82 and after the wedge 60 has been inserted, at step 80, the fabric in the area of the surface formed by the sides 52, 54 of the limbs 44 of preformed coils 40 and wedge 60 is removed.

FIG. 7a shows how at step 72 the fabric or non-woven material 64 is inserted into the stator groove 16, wherein the fabric or non-woven material 64 ends suitably flush or slightly below the stator teeth. FIG. 7b shows how the wedge 60 is provided with the wrapped fabric or non-woven material 64 and then pressed between the preformed coils at step 80. FIG. 7c shows how, according to step 80, in accordance with the second alternative previously mentioned and described with regard to FIG. 5, the fabric or non-woven material 64 is arranged, on the one hand, between the limbs of the preformed coils 40 and the stator teeth and, on the other hand, between the limbs 44 of the preformed coils and the wedge 60.

### REFERENCE LIST

10 wind-turbine-generator stator
12 yoke
14 stator teeth
16 stator grooves
18 circumferential direction
20 height
22 depth
24 groove wall
26 side walls
28 groove base
30 width
40 preformed coil
42 winding heads
44 limb
45 electrical conductor
46a winding
46b winding
46c winding
48 partial winding
50 centre of mass
52 inner sides
54 outer sides
60 wedge
62 area
64 non-woven material
66 filling material
68 groove sealing element
70 provision of a yoke
72 inserting fabric or non-woven material into yoke
74 inserting preformed coils
76 inserting the fabric or non-woven material into an intermediate space
78 inserting fabric or non-woven material into the area between the limbs
80 pressing the wedge into the area between the limbs
82 removing fabric or non-woven material
84 placement of filling material
86 sealing groove
90 heating or baking wind-turbine-generator stator
100 wind turbine
102 tower
104 nacelle
106 aerodynamic rotor
108 rotor blades
110 spinner

1-15. (canceled)

16. A wind-turbine-generator stator comprising:
a plurality of stator teeth;
stator grooves arranged alternately in a circumferential manner; and
a plurality of preformed coils inserted into the stator grooves, wherein each of the plurality of performed coils is a partial winding of at least one electrical conductor, wherein
the partial winding has winding heads arranged at two opposite ends of the partial winding and two parallel limbs,
each of the two parallel limbs having a corresponding inner side and a corresponding outer side;
in at least one of the stator grooves, the two parallel limbs of different preformed coils are inserted in such a way that corresponding outer sides of the two parallel limbs face each other and corresponding inner sides of the two parallel limbs face a different one of the plurality of stator teeth delimiting the stator grooves, and
a wedge is pressed between the corresponding outer sides of the two parallel limbs such that, with the wedge on each of the two parallel limbs, a force is exerted onto the corresponding outer side of the two parallel limbs.

17. The wind-turbine-generator stator according to claim 16, wherein the wedge of a plastic.

18. The wind-turbine-generator stator according to claim 17, wherein the plastic is a glass-fibre reinforced plastic (GRP).

19. The wind-turbine-generator stator according to claim 16, wherein a woven fabric or non-woven material is arranged between the wedge and the two parallel limbs.

20. The wind-turbine-generator stator according to claim 19, wherein the woven fabric is a glass or a PET fabric and the non-woven material is the glass or a PET non-woven material.

21. The wind-turbine-generator stator according to claim 16, wherein a fabric or non-woven material is arranged between the two parallel limbs and a groove wall of the stator grooves.

22. The wind-turbine-generator stator according to claim 21, wherein the fabric is a glass or a PET fabric and the non-woven material is the glass or a PET non-woven material.

23. The wind-turbine-generator stator according to claim 19, wherein the woven fabric or the non-woven material is a resin-impregnated fabric or a resin-impregnated non-woven material before the insertion of one or more of the wedge and the two parallel limbs, in a half-cured state and is converted to a fully cured state by a heating process of the wind-turbine-generator stator.

24. The wind-turbine-generator stator according to claim 16, wherein the stator grooves are sealed with a groove sealing element.

25. The wind-turbine-generator stator according to claim 24, wherein the groove sealing element is a glass-fibre reinforced plastic.

26. The wind-turbine-generator stator according to claim 20, wherein, between a surface formed by the two parallel limbs of the plurality of preformed coils, the wedge, and the groove sealing element, a filling material is arranged, wherein the filling material is a resin-impregnated plastic non-woven material.

27. A method for manufacturing a wind-turbine-generator stator, the method comprising:
providing a wind-turbine-generator stator yoke with a plurality of alternately arranged stator teeth and stator grooves;
inserting two parallel limbs of different ones of a plurality of preformed coils into at least one of the stator grooves; and
pressing in a wedge between outer sides of the two parallel limbs of the different ones of the plurality of preformed coils inserted in the at least one of the stator grooves such that, on each limb of the two parallel limbs, a force is exerted onto the outer sides of the respective limb of the two parallel limbs.

28. The method according to claim 27, wherein at least one of:
a fabric or non-woven material is inserted into the at least one of the stator grooves between the two parallel limbs and a groove wall of the at least one of the stator grooves prior to insertion of the two parallel limbs, or
the fabric or the non-woven material is arranged between the two parallel limbs on the outer side of the two parallel limbs or on the wedge such that, after the wedge has been pressed in, the fabric or the non-woven material is arranged between the outer sides of the two parallel limbs and the wedge.

29. The method according to claim 28, wherein
the fabric or the non-woven material is inserted between the wedge and the outer sides of the limbs and is initially shifted or flipped into the stator grooves around the plurality of preformed coils into an area between the two parallel limbs of the plurality of preformed coils prior to the insertion of the plurality of preformed coils and, after insertion of the plurality of preformed coils before the wedge is pressed in, or
the fabric or the non-woven material is arranged over both lateral surfaces around an edge or a side of the wedge facing a groove bottom after the insertion and before the wedge is pressed in.

30. The method according to claim 29, wherein the fabric or the non-woven material is removed in the area or on lateral surfaces of the two parallel limbs, normal vectors of which point away from the groove bottom.

31. The method according to claim 27, wherein the stator grooves are sealed using a groove sealing element after the plurality of preformed coils have been inserted and the wedge has been pressed in, wherein, the wind-turbine-generator stator is heated or baked after the groove sealing element has been inserted into the stator grooves.

32. The method according to claim 31, wherein a filling material is introduced between a surface formed by the limbs and the wedge and the groove sealing element before closing the stator grooves with the groove sealing element.

33. A wind-turbine generator comprising:
the wind-turbine-generator stator of claim 16.

34. A wind turbine comprising:
the wind-turbine generator according to claim 33

35. A wind turbine comprising:
a wind turbine-generator stator according to claim 16.
